(19) United States
(12) Patent Application Publication
(10) Pub. No.: US 2004/0152001 A1
(43) Pub. Date: Aug. 5, 2004

(54) Base for photosensitive drum composed of resin composition and photosensitive drum using the same

(76) Inventors: Munenori Iizuka, Tokyo (JP); Takahiro Suzuki, Tokyo (JP); Kunio Machida, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/478,658

(22) PCT Filed: May 29, 2002
(86) PCT No.: PCT/JP02/05204

(30) Foreign Application Priority Data
May 29, 2001 (JP) 2001-160480

(51) Int. Cl. B29D 22/00

(52) U.S. Cl. 430/69; 428/35.7

(57) ABSTRACT

A base-body for photosensitive drum comprising resin composition assembled to an image formation apparatus, wherein the base-body comprises a main frame, a flange portion with a thickness of from 0.1 mm to 5 mm and a gear at one end of the main frame integrally injection molded. According to the present invention, a base-body for photosensitive drum comprising a main frame, a flange portion and a gear both provided at one end of the main frame can be integrally molded by injection molding a resin composition without deformation of the gear in the timing of release from the mold. Therefore, a photosensitive drum provided from the base-body for photosensitive drum of the present invention is superior in rotational accuracy, driving transmission and has capability of forming a favorable image of high quality.

### TECHNICAL FIELD

The present invention relates to a base-body for a photosensitive drum (may be merely referred to as “a base-body for a photosensitive drum” below) composed of resin composition and a photosensitive drum using the same. More particularly, the present invention relates to a base-body for a photosensitive drum that is employed as a base-body for a photosensitive drum to be assembled for high-speed image formation apparatus such as an electrophotographic apparatus or an electrostatic recording apparatus; and a photosensitive drum using the base-body for a photosensitive drum. The base-body for a photosensitive drum comprises a gear through a flange portion at the end of the base-body and is integrally molded by injection molding.

### BACKGROUND OF THE INVENTION

In the conventional electrostatic recording process in an electro photographic apparatus or an electrostatic recording apparatus such as a copying machine, a facsimile equipment, and a printer, an electrostatic latent image is formed by uniformly charging the surface of a photosensitive drum with photoconductive material [for example, ZnO, Cds, Se, OPC (organic semiconductor), amorphous silicon (a-Si), etc.] layer. Then, a toner image is formed by erasing electrostatic charge of the light-irradiated area irradiated imagewisely on the layer from optical system and subsequently supplying a toner on the resultant electrostatic latent image by electrostatic adhesion, and by transferring the resultant toner image to recording media such as paper, photographic paper, etc. or a sheet for an overhead projector, a recorded image is obtained.

In a photosensitive drum employed for the aforementioned electrostatic recording processes, a cylindrical or columnar drum base-body made of aluminum alloy obtained by molding has been conventionally utilized because of lightweight, fine machining capability thereof as well as good electroconductivity. Recently however, a cylindrical resinous base-body made of an electroconductive resin composition by injection molding has been utilized too. Such composition is a mixture of a thermoplastic resin and an electroconductive material such as carbon black. This cylindrical resinous base-body has many advantages as the followings: Integral molding is applicable for accessories such as the flange or the gear along with base-body part. It operates with less vibration and with low noise. Few charge leaks from the cylindrical resinous base-body. Damping characteristic of the potential regarding the cylindrical resinous base-body is gentle. Recycling performance of the cylindrical resinous base-body improve.

Unfortunately, in the case of integral molding of the cylindrical resinous base-body having a gear at an end thereof by injection molding, the release of the molded body from the mold by ejector-pin forces the end of the gear during the cooling of the molded article, which is about 120° C. similar to the temperature of the mold, causing undesirable results of the gear deformation. The deformation causes imprecision and also affects adversely to the system movement due to occurrence of improper motion of the drum and inferior drive-transmission.

### DISCLOSURE OF INVENTION

Under such situation, an object of the present invention is to provide an integral molding method of base-body for the photosensitive drum with the structure having a gear at one end of the drum preventing the deformation in the timing of release from the mold. It is another object of the present invention to provide a base-body for the photosensitive drum and photosensitive drum using the same.

As a result of zealously repeated study by the inventors in order to achieve the objects, it was found out that a cylindrical resinous base-body with the structure having a gear attached through a flange portion of a specified thickness at one end of the base-body could overcome the above-described problems. This invention was completed based on these findings.

Namely, the present invention provides a method for producing a base-body for a photosensitive drum comprising resin composition characterized in integrally molding the base-body comprising a main frame, a flange and a gear at one end of the main frame by injection molding.

In other words, this invention provides base-body for photosensitive drum comprising resin composition assembled to an image formation apparatus, wherein the base-body comprises a main frame, a flange portion with a thickness of from 0.1 mm to 5 mm and a gear at one end of the main frame integrally injection molded.

Moreover, this invention provides a photosensitive drum having photosensitive layer on the surface of the base-body for photosensitive drum.

### BRIEF DESCRIPTION OF DRAWINGS

FIG. 1 is a fragmentary cross-sectional view of the base-body for photosensitive drums obtained in Example 1.

### THE MOST PREFERRED EMBODIMENT TO CARRY OUT THE INVENTION

A base-body for photosensitive drum of this invention has the structure with a gear attached through a flange portion at one end of the base-body, and is produced by integral injection molding.

The thickness of the flange portion is necessary to be among the range of from 0.1 to 5 mm. The thickness is preferable to be from 0.2 to 3 mm, and particularly preferable to be from 0.4 to 2 mm. When the thickness of the flange portion is less than 0.1 mm, the strength of the flange portion is not enough, and it becomes impossible to prevent deformation of the gear at the timing of pushing out the molded body with an ejector-pin while releasing from the mold. Moreover, it is not necessary for the thickness of the flange portion to be more than 5 mm, and when it exceeds 5 mm, the width between the base-body and the gear becomes large, and a problem occurs such as difficulty of space reservation in a printer apparatus. Moreover, the thickness of greater than 5 mm easily causes shrink marks particularly in gear portion induced by disturbance of fluid flow of the resin composition during injection molding. This may cause deterioration of accuracy of the gear, resultant degradation of rotational accuracy of the photosensitive drum, and further, aggravation of image qualities. Further, among adjacent driving members such as a charging roller, a transferring roller and the like, a clearance between a driving gear and the functional roller members becomes wide, and accordingly, rotational accuracy, roller function, etc., may degrade thereby deteriorating image qualities.

Further, the external diameter of the flange portion is not restricted so long as it is more than the maximum external diameter of the gear, and in the case of designing the printer, it is preferable to design not to interfere with rotating parts such as any other rollers. For example, it is desirable to determine the demention of each portion of the base-body for photosensitive drum of the present invention as follows:

| | | |
|---|---|---|
| External diameter of the main frame: | 28 to 30 | mm |
| Length of the main frame: | 250 to 270 | mm |
| Thickness of a peripheral wall of the main frame: | 1.5 to 2.0 | mm |
| External diameter of the flange portion: | 32 to 38 | mm |
| Thickness of the flange portion: | 0.1 to 5 | mm |
| Height of the flange portion: | 2 to 4 | mm |
| Maximum external diameter of the gear: | 30 to 35 | mm |
| Width of the gear: | 3 to 6 | mm |

The base-body for photosensitive drum of the present invention is produced by injection molding of an electroconductive resin composition.

A resin component composing the electroconductive resin composition comprises a substrate resin and a slightly hygroscopic resin as an optional component. Although there is no limitation for the substrate resin, a thermoplastic resin is preferable. Although it is possible to select optionally a suitable resin, among from the conventionally used, regarding the resin component of the base-body for photosensitive drums, a polyamide (PA)-based resin and a polyester-based resin are preferable due to the better surface smoothness, and also excellent chemical resistance, mechanical strength and the like. Typical examples of the polyamide-based resin include Nylon 46, Nylon 6, Nylon 66, slightly hygroscopic polyamide with water absorption of up to 1.0% such as Nylon 11, Nylon 12, Nylon MXD6, Nylon 610, Nylon 612, etc., and these copolymerization product and the like. Among these polyamides, Nylon-6, Nylon-66 and slightly hygroscopic polyamide are preferable because of excellent and low cost molding ability thereof, and the slightly hygroscopic polyamide is more preferable. Examples of the polyester-based resin include polyethylene terephthalate, polyethylenenaphthalate, polypropylene terephthalate, polybutylene terephthalate and these copolymerization product, etc. Among these polyester-based resins, polybutylene terephthalate is preferable because of its superiority in molding ability, dimensional stability and low cost. The foregoing polyamide-based resin and polyester-based resin may be employed alone or in combination of two or more kinds thereof.

In order to restrain dimensional change by water absorption and the like of the base-body for photosensitive drum, a resin with water absorption up to 0.3% measured in accordance with ASTM-D570 (referred to as “slightly hygroscopic” hereunder) may be combinedly employed with the foregoing substrate resin. Typical examples of the slightly hygroscopic resin include polypropylene (PP), polyphenyleneether (PPE), polyphenylene sulfide (PPS) and so on, being selected appropriately taking compatibility, etc., with the substrate resin in consideration.

Further, the base-body for photosensitive drum with low water absorption even when a resin like polyamide resin with high water absorption is employed as the substrate resin, and with small dimensional change even under an environment of elevated temperature and high humidity can be obtained by the use of a polymer alloy blending the foregoing slightly hygroscopic resin into the substrate resin. For example, in order to obtain the polymer alloy blending the substrate resin and the slightly hygroscopic resin, a blending ratio of the slightly hygroscopic resin to the substrate resin is preferable to be 1 to 70 mass %, more preferable to be 5 to 50 mass %, and particularly more preferable to be 10 to 40 mass %.

With regard to the blending, a compatibility agent having excellent affinity with both the substrate resin and the slightly hygroscopic resin may be appropriately contained in order to improve the compatibility between these resins and in order to raise dispersibility, thereby improving mechanical characteristics like strength, water absorption, and chemical resistance against medicine. Typical examples of the compatibility agent include maleic acid modified polypropylene (maleic acid modified PP) for PA-PP based combination; epoxy modified polystyrene (epoxy modified PS)-polymethyl methacrylate (PMMA) copolymer, etc., for PA-PPS based or PA-PPE based combination.

As the foregoing description, the polymer alloy obtained by blending slightly hygroscopic resin with the substrate resin of the present invention reveals superior dimensional stability as compared with, for example, a molded article with the use of a polyamide resin alone as the resin component. Reference examples comparing these issues are shown in Table 1 below. The water absorption and the dimensional change shown in Table 1 below were obtained by measuring the differences between before and after leaving the molded article within high temperature-high humidity tank under an environment of 50° C. and 95% in relative humidity for 24 hours. An exciting improvement in the water absorption and the dimensional stability of the molded article under the high temperature and high humidity environment by blending the slightly hygroscopic resin into the polyamide resin is recognized.

TABLE 1

| | Reference Example | | | | | |
|---|---|---|---|---|---|---|
| | 1 | 2 | 3 | 4 | 5 | 6 |
| Substrate Resin (mass %) | | | | | | |
| PA66 | 70 | 70 | 70 | 42 | 42 | 42 |
| Slightly Hygroscopic Resin | | | | | | |
| (mass %) | | | | | | |
| PPE | — | — | — | 28 | — | — |
| PPS | — | — | — | — | 28 | — |
| PP | — | — | — | — | — | 28 |
| Electroconductive Material | | | | | | |
| (mass %) | | | | | | |
| KETJENBLACK | 10 | 10 | 10 | 10 | 10 | 10 |
| Reinforcing material (mass %) | | | | | | |
| Potassium Titanate Whisker | 10 | 20 | 30 | 20 | 20 | 20 |
| Water Absorption (%)*¹ | 1.6 | 1.5 | 1.3 | 0.4 | 0.2 | 0.3 |
| Dimensional Change (%)*² | 1.12 | 1.05 | 0.95 | 0.3 | 0.2 | 0.4 |

*¹Measured in accordance with ASTM D-570
*²Dimensional change rate in flow direction
PA 66: Nylon 66, “UBE nylon” available from Ube Industries, Ltd.
PPE: (modified polyphenylene eter) “xyron” available from Asahi Kasei Corporation.
PPS: “Susteel” available from Tosoh Corporation.
PP: “Mitsubishi polypro” available from Mitsubishi chemical Corporation.
KETJENBLACK: Carbon black available from Lion Corporation.
Potassium titanate Whisker: “TISMO” available from Otsuka Chemical Co., Ltd.

As the foregoing resin component, Nylon 66+Nylon 6, Nylon 66+Nylon MXD6, Nylon 66+ slightly hygroscopic resin (polymer alloy), slightly hygroscopic polyamide and polybutylene terephthalate are preferably employed, slightly hygroscopic polyamide and polybutylene terephthalate are more preferably employed and polybutylene terephthalate is particularly preferably employed.

The electroconductive resin composition is generally prepared by blending an electroconductive material with one of the foregoing resin components. Such electroconductive material is not restricted so long as it is dispersed uniformly into the resin component and typical examples are carbon black, graphite, metal powders such as aluminum, copper, nickel and the like, electroconductive glass powder, and so on. But, carbon black is particularly preferable.

The blending amount is usually from 5 to 50% by weight, preferably from 5 to 30% by weight based on total amount of the resin component.

When the base-body for photosensitive drum of the present invention is employed, for example, as the photosensitive drum for high speed image formation apparatus with capacity of printing at the rate of about 20 to 40 sheets/minute, it is desirable that the surface resistance value is less than 1×10⁵ Ω/□. When the surface resistance value is 1×10⁵ Ω/□ or more, troubles such that surface potential characteristic (damping characteristic of potential during exposure) reduces or that unfavorable image quality such as black spots or fog appears may occur. It is more desirable to be less than 1×10⁴ Ω/□, particularly desirable to be less than 1×10³ Ω/□, and the most desirable to be 1×5×10² Ω/□ or less. Further, with regard to the lower limit of the surface resistance value, it is not particularly specified, however, it is preferable to be 1×10⁰ Ω/□ or more taking the other physical properties of the base-body for photosensitive drum into consideration. Furthermore, it is desirable to be 1×10¹ Ω/□ or more considering manufacturing cost, productivity etc. Accordingly, the most preferable range of the surface resistance value is from 1×10¹ to 5×10² Ω/□. Additionally, a measuring method of the surface resistance value will be explained afterwards. The surface resistance value within the foregoing range makes the molding work of the resultant base-body for photosensitive drum easy, improves damping characteristic of potential during exposure, and further, enables to suppress the generation of unfavorable image quality.

Reduction in weight of the base-body for photosensitive drum of the present invention while maintaining the dimensional accuracy (accuracy of internal and external diameter, revolutional deflection, out-of-roundness, straightness, etc.) will be effectively realized by adjusting the water absorption of the electroconductive resin composition up to 1.5%. The water absorption is defined as the value measured in accordance with ASTM D-570.

When the water absorption of the electroconductive resin composition exceeds 1.5%, the dimensional accuracy (accuracy of internal and external diameter, revolutional deflection, out-of-roundness, straightness, etc.) may not be maintained in the use condition, for example, under high temperature and high humidity. Additionally, the water absorption of the elecroconductive resin composition is more preferable to be 0.7% or less, particularly preferable to be 0.5% or less. Furthermore, it is desirable in the present invention that the difference of the external diameters at both ends of the base-body for photosensitive drum between before and after leaving it under the condition of 50° C. and relative humidity of 90% for 24 hours is 0.1 mm or smaller, particularly 0.05 mm or smaller. The difference might be obtained by subtracting the external diameter before leaving from the external diameter after leaving.

Izod impact value of the electroconductive resin composition of at least 20 J/m is effective in order that the high quality base-body for photosensitive drum without being damaged by the impact receiving during transport or by dropping and with sufficient strength equivalent to a metallic base-body for photosensitive drum is provided.

Fillers such as various fibers, Whiskers and the like may be optionally contained in the resin composition for forming the base-body for photosensitive drum of this invention with the aim of reinforcement or weight gain. Typical examples of the filler include electroconductive inorganic fibers such as electroconductive whisker, electroconductive glass fiber and the like, electroconductive fillers such as Whisker, carbon fiber and the like, and non-electroconductive filler such as glass fiber and the like. The electroconductive filler acts as an electroconductive material, and it is probable to decrease the amount of the electroconductive material such as carbon black incorporating to the resin composition.

Regarding the blending amount of the filler, there is no limitation in particular, and may be selected depending on the kind of the filler, the length and the diameter of the fiber, etc. appropriately. Usually, the amount is preferable to be from 1 to 30% by weight based on a total amount of the conductive resin composition, more preferable to be from 5 to 25% by weight, and desirable to be from 10 to 25% by weight.

Further, if it is required, a known additive such as polytetrafluoro-ethylene (PTFE), silicone resin, molybdenum disulfide (MoS2), various metal soaps and the like other than the foregoing fillers is possible to be blended with the electroconductive resin composition.

Furthermore, it is possible to execute surface treatment to the electroconductive material; the filler and the like by using a conventional silane-based coupling agent, a titanate-based coupling agent and the like.

The base-body for photosensitive drum of the present invention is molded integrally with the gear and the flange portion by injection molding as aforementioned. Molding conditions such as molding temperature (usually 220 to 290° C.) or injection pressure (usually 50 to 100 MPa) and the like may be appropriately selected depending on the kinds, etc., of the resin component composing the electroconductive resin composition.

According to the present invention, the base-body for photosensitive drum itself has a gear at an end thereof through the flange portion having the aforementioned thickness; therefore there is no gear distortion at the instant of pushing out the molded body with an ejector-pin while releasing from the mold after completion of the injection molding.

Although an outer circumferential surface of the main frame of the base-body for photosensitive drum of the present invention is not particularly restricted, the surface roughness of the outer circumferential surface is preferable to be 0.8 μm or smaller, particularly preferable to be 0.2 μm or smaller expressed as the averaged center line roughness, Ra, preferable to be 1.6 μm or smaller, particularly preferable to be 0.8 μm or smaller expressed as the maximum height, Rmax, and preferable to be 1.6 μm or smaller, particularly preferable to be 0.8 μm or smaller expressed as ten points average roughness, Rz. Excessively large values of these Ra, Rmax and Rz may induce the roughness on the surface of the base-body for photosensitive drum to appear on an exposure layer over the photosensitive drum, thereby cause unfavorable image quality.

The photosensitive drum of the present invention is obtained by forming a photosensitive layer and, if necessary, other layers such as an undercoat layer, a protective layer and the like over the surface of the main frame of the base-body for photosensitive drum of the present invention.

The photosensitive layer is formed by applying a coating solution obtained by dissolving photosensitive agents and binder components into an organic solvent such as alcohol, chloroform, toluene and the like over the outer surface of the cylindrical base-body, and further drying by heat. The coating solution for forming the photosensitive layer may be obtained according to publicly known composition, and the layer structure for forming the photosensitive layer may be obtained according to publicly known structure.

It is desirable for the foregoing photosensitive layer to have, at least, a charge-generating layer and a charge-transporting layer. Herein, the charge-generating layer comprises generally a charge-generating compound and a binder resin. There is no limitation for the charge-generating compound, therefore it is conventionally selected from known compounds being used for a charge-generating layer for photosensitive materials, and conventionally it is selected appropriately from among the publicly known chemical compounds used for the charge-generating layer of photosensitive materials such as various inorganic electroconductive chemical compounds or organic electroconductive chemical compounds. Among these compounds, the chemical compounds having excellent charge generating capability are desirable. Moreover, regarding the binder resin, there is also no limitation in particular, and it is selected appropriately from among the resin publicly known as those used conventionally for charge-generating layers of photosensitive materials. The charge-generating layer can be formed by well-known process of coating or vapor deposition, etc.

On the other hand, it is desirable for the charge-transporting layer to have a heterogeneous charge transporting layer or a homogeneous charge-transporting layer. Regarding the heterogeneous charge-transporting layer, although it is not restricted, a heterogeneous charge-transporting layer containing dispersed-particles, a heterogeneous charge-transporting layer of a phase separated type and the like are preferable. The heterogeneous charge-transporting layer is obtained by using known methods such as application of material-dispersed solvent, wherein the material such as the aforementioned polymer and the like is to be incorporated into the heterogeneous charge-transporting layer.

As the aforementioned homogeneous charge-transporting layer, although it is not restricted, it is preferable to have the higher charge transporting capability and contain polymer materials with excellent film formability. The homogeneous charge transporting layer is obtained by using known methods such as application of material-dispersed solvent, wherein the material such as the aforementioned polymer materials and the like is to be incorporated into the homogeneous charge-transporting layer.

The formation of the base-body for photosensitive drum with the foregoing electroconductive resin composition formed by blending and dispersing the electroconductive materials and fillers into substrate resin such as polyamide resin and the like as well as Izod impact value of the electroconductive resin composition of at least 20 J/m is effective in the prevention of being damaged by the impact receiving during transport or by dropping. The Izod impact value is defined as the value measured in accordance with ASTM D-256.

When the Izod impact value of the electroconductive resin composition is less than 20 J/m, damages by the impact receiving during transport or by dropping will occur because of the insufficient strength and the object of the invention may not be achievable. The Izod impact value is preferably at least 30 J/m, more preferably at least 35 J/m and, in particular, desirably within the range from 35 to 55 J/m.

An appropriate determination of the flexural modulus of the base-body for photosensitive drum may prevent the thermal changes of the external diameter or the straightness as small as possible.

The formation of the base-body for photosensitive drum having the flexural modulus of at least 5×10³ MPa with the electroconductive resin composition will not only provide the formation of the photosensitive layer without causing any thermal changes in the external diameter or straightness by the exposure under heat and without degrading the dimensional accuracy, but also surely provide the photosensitive drum having superiority in dimensional accuracy efficiently suppressing the degradation in dimensional accuracy caused by the contraction during injection molding.

The flexural modulus of the base-body for photosensitive drum is more preferably at least 6×10³ MPa. The flexural modulus of the base-body for photosensitive drum at least 6×10³ MPa will prevent any thermal changes in the external diameter or straightness by the exposure under drying by heat during the formation of the photosensitive layer over the outer surface of the drum as small as possible and thereby improve the dimensional accuracy of the resultant photosensitive drum. Excessively small value of the flexural modulus will induce great thermal changes in the external diameter or straightness by the exposure under drying by heat during the formation of the photosensitive layer and cause degradation of the dimensional accuracy of the resultant photosensitive drum thereby failing to obtain a photosensitive drum having excellent printing capability, and the object of the invention may not be achievable. The greater the flexural modulus, the smaller the degradation by heat of the dimensional accuracy may be restrained, however, the flexural modulus is more preferably within the range from 5×10³ to 20×10³ MPa, and particularly desirable to be within the range from 6×10³ to 14×10³ MPa taking the characteristics of the resin, etc., into consideration.

The bending strength of the base-body-for photosensitive drum is preferable to be 100 to 350 MPa and more preferable to be 100 to 250 MPa. The bending strength within the foregoing range will prevent the vulnerability of the breakdown of the base-body for photosensitive drum under an excessive load during the production as small as possible and will enable to produce the base-body for photosensitive drum with sufficient yields.

The greater the bending strength, the more effective the prevention of the breakdown during the production, however, an excessive great value of the bending strength would easily cause the deformation of the resultant photosensitive drum and would make stably providing favorable image quality difficult. Accordingly, the bending strength is particularly desirable to be 100 to 250 MPa. The bending strength is measured in accordance with ASTM D-790.

Additionally, the adjustment of the bending strength may be conducted by adjusting the constitution of the electroconductive resin composition and, specifically, by the selection of the kinds of the resin component, reinforcing filler and electroconductive material or by the adjustment of these blending ratio.

This invention will be described in further detail with reference to Examples, which does not limit the scope of this invention.

Further, the physical properties of the resin composition and the products were measured in accordance with the following methods:

(1) Surface Resistance Value

By injection molding the electroconductive resin composition with the blending composite as shown in Table 2, a base-body for photosensitive drum with a main frame having an external diameter of 30 mm, a length of 260 mm, with a peripheral wall having a thickness of 1.7 mm, with a flange portion having an external diameter of 36 mm, a thickness of 2 mm, and with a gear having the maximum external diameter of 34 mm and a width of 4 mm was formed.

Applying 90 V (DC) over the surface of the base-body for photosensitive drum, and with the use of the four probe type resistance measuring instrument “Rhoresta GP” ASP probe produced by Mitsubishi Chemical Corporation in accordance with JIS K7194, the surface resistance value was determined by reading at the timing when the ohmic value stabilized.

(2) Water Absorption

The water absorption was measured in accordance with ASTM D-570.

(3) Izod Impact Value (Notched)

Forming test pieces by injection molding the electroconductive resin compositions with blending composite as shown in Table 2, the Izod impact values were measured in accordance with ASTM D-256.

(4) Flexural Modulus

Forming test pieces by injection molding the electroconductive resin compositions with blending composite as shown in Table 2, the Flexural moduli were measured in accordance with ASTM D-790.

(5) Bending Strength

Forming test pieces by injection molding the electroconductive resin compositions with blending composite as shown in Table 2, the Bending strengths were measured in accordance with ASTM D-790.

(6) Drop Test

By injection molding the electroconductive resin compositions as shown in Table 2, a base-body for photosensitive drum with a main frame having an external diameter of 30 mm, a length of 260 mm, with a peripheral wall having a thickness of 1.7 mm, with a flange portion having an external diameter of 36 mm, a thickness of 2 mm, and with a gear having the maximum external diameter of 34 mm and a width of 4 mm was formed. Each resultant cylindrical base-bodies were freely dropped from a height of 1.2 m against a floor made of concrete, and the ratio of the base-bodies for photosensitive drum with the generation of breakdown was determined.

(7) Fraction Defective of Straightness

Preparing the electroconductive resin composition with the blending composite as shown in Table 2 in accordance with an ordinary process, a base-body for photosensitive drum with a main frame having an external diameter of 30 mm, a length of 260 mm, with a peripheral wall having a thickness of 1.7 mm, with a flange portion having an external diameter of 36 mm, a thickness of 2 mm, and with a gear having the maximum external diameter of 34 mm and a width of 4 mm was formed.by injection molding. Each sample was formed with the use of the same metallic mold and the same molding condition. Leaving the resultant base-body for photosensitive drum under heating at 120° C. for 60 minutes and after radiation cooling, the straightness was measured over the full length of the base-body. The term “straightness” is a measure defined in JIS B0021, expressing geometric allowance and the measurement was conducted as the following:

Disposing the base-body for photosensitive drum approximately in parallel with a standard edge with high level of straightness, measuring the clearance between the standard edge and the surface of the base-body for photosensitive drum along the longitudinal direction by means of a laser detector and a laser radiator, plotting the measured data to form a graph, and drawing a standard line contacting with the endpoints at both ends, the maximum differential from the standard line was determined as the straightness. With regard to the base-body for photosensitive drum having the straightness of 50 μm or more, it was decided to be defective and the rate of the numbers of the defective base-bodies out of total resultant base-bodies was determined as fraction defective of straightness.

(8) Fraction Defective of External Diameter Change

The base-body for photosensitive drum was formed in the same manner as the preceding measurement. External diameters at both end portions of the base-body (predetermining one end as A side, and the other end as B side) before and after the heat treatment of leaving it under heating at 120° C. for 60 minutes and radiation cooling were measured. With regard to the base-body for photosensitive drum with external diameter change of 0.1 mm or more, it was decided to be defective and the rate of the numbers of the defective base-bodies out of total resultant base-bodies was determined as fraction defective of external diameter change.

(9) Fraction Defective of Image Qualities

Preparing the electroconductive resin composition with the blending composite as shown in Table 2, a base-body for photosensitive drum with a main frame having an external diameter of 30 mm, a length of 260 mm, with a peripheral wall having a thickness of 1.7 mm, with a flange portion having an external diameter of 36 mm, a thickness of 2 mm, and with a gear having the maximum external diameter of 34 mm and a width of 4 mm was formed. A photosensitive drum was provided by forming a photosensitive layer with a thickness of 30 μm over the surface of the base-body for photosensitive drum Mounting the resultant photosensitive drum on a laser shot printer, printing images with a speed of 20 to 40 pictures/minute, and evaluating the image qualities of the resultant images by visual observation, a generation rate of image unevenness was determined.

(10) Deformation of Gear

The electroconductive resin compositions as shown in Table 2 were injection molded. After the injection molding, by ejecting the molded article from the metallic mold with the temperature of about 120° C. by means of an ejector-pin, a base-body for photosensitive drum with a main frame having an external diameter of 30 mm, a length of 260 mm, with a peripheral wall having a thickness of 1.7 mm, with a flange portion having an external diameter of 36 mm, a thickness of 2 mm, and with a gear having the maximum external diameter of 34 mm and a width of 4 mm was obtained. Presence or absence of a deformation of the gear was evaluated by visual observation.

### EXAMPLES 1 TO 4

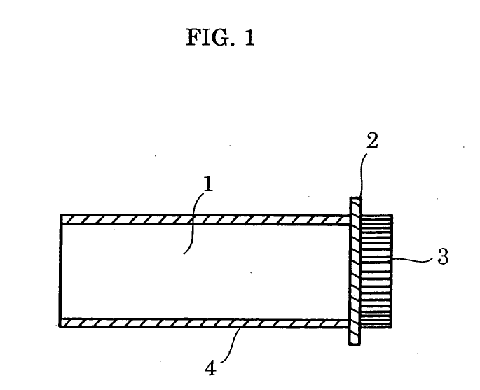

The electroconductive resin compositions were prepared by combining the blending composite as shown in Table 2. Subsequently, base-bodies for photosensitive drum with dimensions as shown in Table 2 were provided by injection molding of the foregoing electroconductive resin compositions under the conditions of molding temperature at 280° C. and injection molding pressure of 70 Mpa. The fragmentary sectional view is shown in FIG. 1. It illustrates only a sectional view of the main frame. As shown in FIG. 1, the base-body for photosensitive drum of the present invention, has a structure with an end of the main flame 1 provided integrally with a gear 3 through a flange portion 2. The numerical symbol 4 shows the peripheral wall of the base-body.

The foregoing evaluations were conducted with regards to the electroconductive resin compositions, base-bodies for photosensitive drum, and photosensitive drums and the results are shown in Table 2.

### Comparative Example 1

A base-body for photosensitive drum was provided in a similar manner as Example 1, with the exception that the flange portion was omitted. In this case, the deformation of the gear at the instant of pushing out the molded body with a ejector-pin while releasing from the mold (its temperature was about 120° C.) was recognized.

### Comparative Examples 2 and 3

A base-body for photosensitive drum was provided in a similar manner as Example 1, with the exception that the thickness of the flange portion were settled as 6 mm (Comparative Example 2) or 8 mm (Comparative Example 3). As is apparent from the results shown in Table 2, when the thickness of the flange portion exceeds 5 mm, the generation rate of image unevenness increases.

TABLE 2

| | | Ex. 1 | Ex. 2 | Ex. 3 | Ex. 4 |
|---|---|---|---|---|---|
| 1 | Electroconductive Resin | | | | |
| | Composition | | | | |
| | Substrate Resin (mass %) | | | | |
| | PA66 | 30 | — | — | — |
| | PA6 | 30 | — | — | — |
| | PBT | — | 45 | 35 | 45 |
| | Electroconductive Material | | | | |
| | (mass %) | | | | |
| | KETJENBLACK | 10 | — | — | — |
| | Furnaceblack | — | 20 | 20 | 20 |
| | Fillers (mass %) | | | | |
| | Potassium Titanate Whisker | 30 | — | — | — |
| | Wallastonite | — | 35 | 45 | 35 |
| 2 | Physical Properties of the | | | | |
| | Composition | | | | |
| | Surface Resistance | 2.10 | 1.50 | 1.00 | 2.00 |
| | Value (10² Ω/□) | | | | |
| | Water Absorption (%) | 1.5 | 0.04 | 0.03 | 0.05 |
| | Izod Impact Value: Notched | 51 | 36 | 28 | 37 |
| | (J/m) | | | | |
| | Flexural Modulus (10³ Mpa) | 8.3 | 6.5 | 7.8 | 6.3 |
| | Bending Strength (Mpa) | 145 | 116 | 132 | 108 |
| 3 | Shape of Base-Body | | | | |
| | Main Frame | | | | |
| | External Diameter (mm) | 29.8 | 29.6 | 29.9 | 29.6 |
| | Length (mm) | 260 | 260 | 260 | 260 |
| | Thickness of the peripheral | 1.7 | 1.7 | 1.8 | 1.7 |
| | wall (mm) | | | | |
| | Flange Portion | | | | |
| | External Diameter (mm) | 38 | 38 | 38 | 38 |
| | Thickness (mm) | 2 | 2 | 2 | 4 |
| | Height (mm) | 3 | 3 | 3 | 3 |
| | Gear | | | | |
| | Maximum External Diameter | 34.1 | 34.3 | 34.6 | 34.5 |
| | (mm) | | | | |
| | Width (mm) | 4.1 | 4.4 | 4.3 | 4.4 |
| 4 | Product Performance | | | | |
| | Drop Test | | | | |
| | Breakdown Generation Ratio | 0.05 | 0.04 | 0.03 | 0.04 |
| | (%) | | | | |
| | Fraction Defective of | 1 | 0.9 | 0.2 | 0.7 |
| | Straightness (%) | | | | |
| | FD of External Diameter | | | | |
| | Change (%) | | | | |
| | A Side (%) | 0.8 | 0.4 | 0.2 | 0.3 |
| | B Side (%) | 0.6 | 0.3 | 0.1 | 0.2 |
| | FD of Image Qualities | | | | |
| | Deformation of Gear | N.O. | N.O. | N.O. | N.O. |

| | | Com. | Com. | Com. |
|---|---|---|---|---|
| | | Ex. 1 | Ex. 2 | Ex. 3 |
| 1 | Electroconductive Resin Composition | | | |
| | Substrate Resin (mass %) | | | |
| | PA66 | 30 | — | — |
| | PA6 | 30 | — | — |
| | PBT | — | 45 | 45 |
| | Electroconductive Material (mass %) | | | |
| | KETJENBLACK | 10 | — | — |
| | Furnaceblack | — | 20 | 20 |
| | Fillers (mass %) | | | |
| | Potassium Titanate Whisker | 30 | — | — |
| | Wallastonite | — | 35 | 35 |
| 2 | Physical Properties of the | | | |
| | Composition | | | |
| | Surface Resistance Value (10² Ω/□) | 1.30 | 2.30 | 1.10 |
| | Water Absorption (%) | 1.5 | 0.04 | 0.05 |
| | Izod Impact Value: Notched (J/m) | 49 | 35 | 37 |
| | Flexural Modulus (10³ Mpa) | 7.5 | 6.6 | 6.1 |
| | Bending Strength (Mpa) | 151 | 138 | 129 |
| 3 | Shape of Base-Body | | | |
| | Main Frame | | | |
| | External Diameter (mm) | 29.8 | 29.6 | 29.9 |
| | Length (mm) | 260 | 260 | 260 |
| | Thickness of the peripheral wall | 1.7 | 1.7 | 1.7 |
| | (mm) | | | |
| | Flange Portion | | | |
| | External Diameter (mm) | — | 38 | 38 |
| | Thickness (mm) | — | 6 | 8 |
| | Height (mm) | — | 3 | 3 |
| | Gear | | | |
| | Maximum External Diameter (mm) | 34.1 | 34.1 | 34.1 |
| | Width (mm) | 4.1 | 4.1 | 4 |
| 4 | Product Performance | | | |
| | Drop Test | | | |
| | Breakdown Generation Ratio (%) | 0.05 | 0.04 | 0.04 |
| | Fraction Defective of | 0.8 | 0.3 | 0.3 |
| | Straightness (%) | | | |
| | FD of External Diameter | | | |
| | Change (%) | | | |
| | A Side (%) | 0.6 | 0.2 | 0.3 |
| | B Side (%) | 0.4 | 0.1 | 0.2 |
| | FD of Image Qualities | | | |
| | Generation Ratio of | 0.4 | 0.8 | 1.1 |
| | Image Unevenness (%) | | | |
| | Deformation of Gear | Observed. | N.O. | N.O. |

In Table 2, “FD” means Fraction Defective and “N.O.” means “Not Observed”.

PA 66: Nylon 66, “UBE nylon” available from Ube Industries, Ltd.

PA 6: Nylon 6, “UBE nylon” available from Ube Industries, Ltd. PBT: Polybutylene terephthalate “DURANEX” available from Polyplastics Co., Ltd.

KETJENBLACK: Carbon black available from Lion Corporation. Furnaceblack: “AX-015” available from ASAHI CARBON Co., Ltd. Potassium titanate Whisker: “TISMO” available from Otsuka Chemical Co., Ltd.

Wallastonite: “Wollastonite” available from KAWATETSU MINING CO., LTD.

Industrial Applicability

According to the present invention, a base-body for photosensitive drum comprising a main frame, a flange portion and a gear both provided at one end of the main frame can be integrally molded by injection molding a resin composition without deformation of the gear in the timing of release from the mold.

What is claimed is:

1. A method for producing a base-body for a photosensitive drum comprising resin composition characterized in integrally injection molding the base-body comprising a main frame, a flange portion and a gear at one end of the main frame.

2. The method according to claim 1, wherein the thickness of said flange portion is from 0.1 to 5 mm.

3. A base-body for photosensitive drum comprising resin composition assembled to an image formation apparatus, wherein the base-body comprises a main frame, a flange portion with a thickness of from 0.1 mm to 5 mm and a gear at one end of the main frame integrally injection molded.

4. The base-body for photosensitive drum according to claim 3, wherein said resin composition comprises at least one kind selected from a group containing polyamide-based resin and polyester-based resin.

5. The base-body for photosensitive drum according to claim 4, wherein said polyamide-based resin is at least one kind selected from a group comprises Nylon 66, Nylon 6 and Nylon 612.

6. The base-body for photosensitive drum according to claim 4, wherein said polyester-based resin is polybutylene terephthalate.

7. The base-body for photosensitive drum according to any one of claims 3 to 6, wherein said resin composition further comprises an electroconductive material.

8. The base-body for photosensitive drum according to any one of claims 3 to 7, wherein said resin composition further comprises a filler.

9. A photosensitive drum having a photosensitive layer applied over the surface of said base-body for photosensitive drum according to claims 3 to 8.
